(19) United States
(12) Patent Application Publication
(10) Pub. No.: US 2007/0297516 A1
(43) Pub. Date: Dec. 27, 2007

(54) Optimization methods for objective measurement of video quality

(76) Inventor: Chulhee Lee, Goyang-City (KR)

Correspondence Address: Chulhee Lee, Dept. Electrical and Electronic Eng., Yousei University, Seoul, 120-749, KR

(21) Appl. No.: 11/896,950

(22) Filed: Sep. 7, 2007

Related U.S. Application Data
(62) Division of application No. 10/082,081, filed on Feb. 26, 2002, now abandoned.

(51) Int. Cl. H04N 7/12

(52) U.S. Cl. 375/240.19; 375/E07.076

(57) ABSTRACT

An optimization method, which finds the optimal weight vector, is provided. The method finds the optimal weight vector which is used to produce an objective score from a parameter vector. Such objective scores provide the maximum correlation coefficient with subjective scores.

This application is a divisional of application Ser. No. 10/082,081 filed Feb. 26, 2002 entitled “Methods for objective measurement of video quality”, which is herein incorporated by reference.

### BACKGROUND OF THE INVENTION

1. Field of the Invention

This invention relates to methods for objective measurement of video quality and an optimization method that finds the best linear combination of various parameters.

2. Description of the Related Art

Traditionally, the evaluation of video quality is performed by a number of evaluators who evaluate the quality of video subjectively. The evaluation can be done with or without reference videos. In referenced evaluation, evaluators are shown two videos: the original (reference) video and the processed video that is to be compared with the original video. By comparing the two videos, the evaluators give subjective scores to the videos. Therefore, it is often called a subjective test of video quality. Although the subjective test is considered to be the most accurate method since it reflects human perception, it has several limitations. First of all, it requires a number of evaluators. Thus, it is time-consuming and expensive. Furthermore, it cannot be done in real time. As a result, there has been a great interest in developing objective methods for video quality measurement. Typically, the effectiveness of an objective test is measured in terms of correlation with the subjective test scores. In other words, the objective test, which provides test scores that most closely match the subjective scores, is considered to be the best.

In the present invention, new methods for objective measurement of video quality are provided using the wavelet transform. In particular, the characteristic of the human visual system whose sensitivity varies in spatio-temporal frequencies is taken into account. In order to compute the spatio-temporal frequencies, the wavelet transform is used. In order to take into account the temporal frequencies, a modified 3-D wavelet transform is provided. The differences in the spatio-temporal frequencies are calculated by summing the difference (squared error) of the wavelet coefficients in each subband. Then, the differences in the spatio-temporal frequencies are represented as a vector. Each component of this average vector represents a difference in a certain spatio-temporal frequency band. From this vector, a number is computed as a weighted sum of the elements of the vector and that number is used as an objective quality measurement. In order to find the optimal weight vector, an optimization procedure is provided. The procedure is optimal in the sense that it provides gives the largest correlation with the subjective scores.

### SUMMARY OF THE INVENTION

Due to the limitations of the subjective test, there is an urgent need for a method for objective measurement of video quality. In the present invention, new methods for objective measurement of video quality using the wavelet transform are provided. The wavelet transform can exploit the characteristics of the human visual system, which varies in spatio-temporal frequencies. The wavelet transform analysis produces a number of parameters, which can be used to produce an objective score. In the present invention, the parameters are represented as a parameter vector, from which a number is computed. Then, the number is used as an objective score. In order to find the best linear combination of the parameters, an optimization procedure is provided.

Therefore, it is an object of the present invention to provide new methods for objective measurement of video quality utilizing the wavelet transform.

It is another object of the present invention to provide an optimization procedure that finds the best linear combination of various parameters that are obtained for objective measurement of video quality.

The other objects, features and advantages of the present invention will be apparent from the following detailed description.

### BRIEF DESCRIPTION OF THE DRAWING

FIG. 1a shows an original image.

FIG. 3b shows an example of a 3-level wavelet transform of the original image of FIG. 1a.

FIG. 2 illustrates the subband block index of a 3-level wavelet transform.

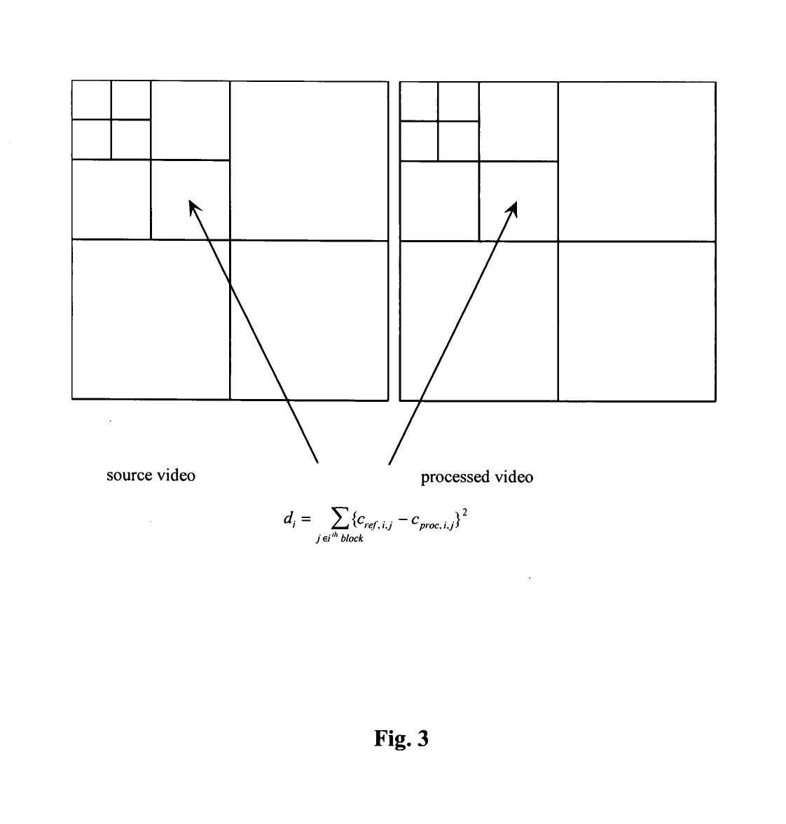

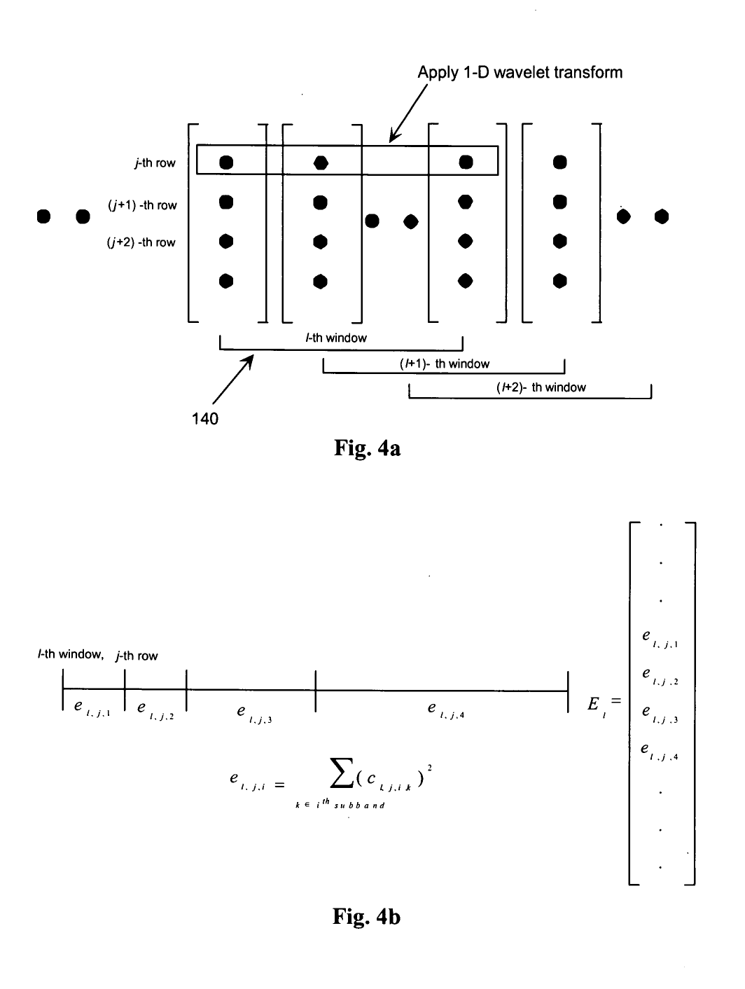

FIG. 3 illustrates how the squared error in the i-th block is computed.

FIG. 4a illustrates how the modified 3-dimensional wavelet transform is computed.

FIG. 4b illustrates how a new difference vector is computed.

### DESCRIPTION OF THE ILLUSTRATED EMBODIMENTS

### Embodiment 1

The present invention for objective video quality measurement is a full reference method. In other words, it is assumed that a reference video is provided. In general, videos can be understood as a sequence of frames. One of the simplest ways to measure the quality of a processed video is to compute the mean squared error between the reference and processed videos as follows:

$${e}_{mse} = \frac{1}{L M N} {\sum }_{l}^{} {\sum }_{m}^{} {\sum }_{n}^{} {( U ( l , m , n ) - V ( l , m , n ) )}^{2}$$

where U represents the reference video and V the processed video. M is the number of pixels in a row, N the number of pixels in a column, and L the number of the frames. However, the sensitivity of the human visual system varies in different frequencies. In other words, the human eye may perceive the differences in various frequency components differently and this characteristic of the human visual system can be exploited to develop an objective measurement method for video quality. Instead of computing the mean square error between the reference and processed videos, a weighted difference of various frequency components between the reference and processed videos is used in the present invention. There are mainly two types of frequency components for video signals: spatial frequency components and temporal frequency components. High spatial frequencies indicate sudden changes in pixel values within a frame. High temporal frequencies indicate rapid movements along a sequence of frames. In the case of color videos, there are three color components and frequency components can be computed for each color. A number of techniques have been used to compute the frequency component and some of the most widely used methods include the Fourier transform and wavelet transform. In the present invention, the wavelet transform is used. However, it is noted that one may use the Fourier transform and still benefit from the teaching of the present invention.

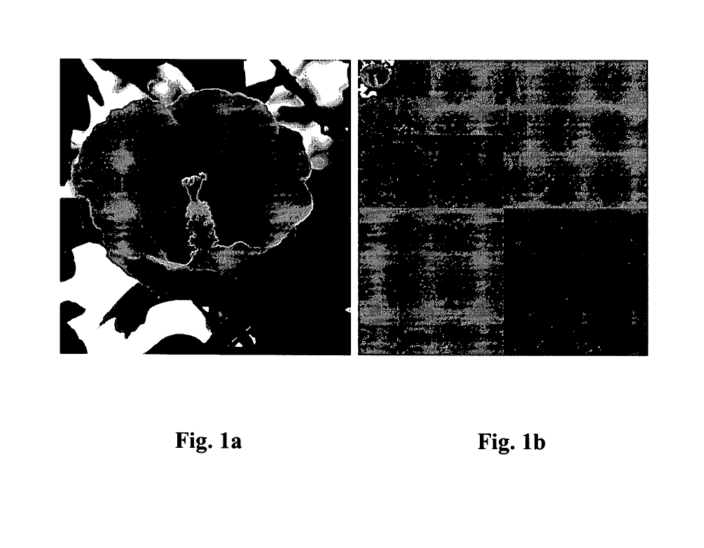

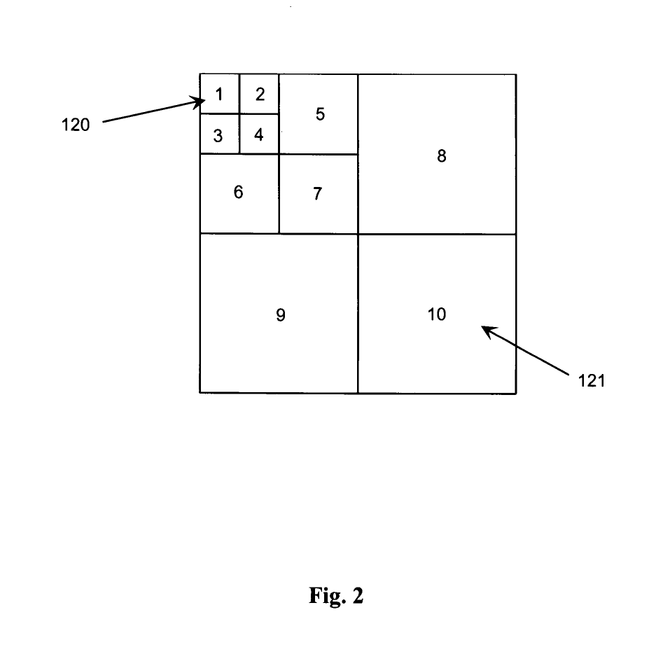

FIG. 1a shows an example of a 3 level wavelet transform of the original image of FIG. 1a. In a 3 level wavelet transform, there are 10 blocks, as can be seen in FIG. 2. Each block represents various spatial frequency components. The block 120 in the upper left-hand corner represents the lowest spatial frequency component of the frame and the block 121 in the lower right-hand block the highest spatial frequency component. In a 2 level wavelet transform, there are 7 blocks. On the other hand, in a 4 level wavelet transform, there are 13 blocks.

In order to compute spatial frequency components, the wavelet transform is applied to each frame of source and processed videos. Then, the difference (squared error) of the wavelet coefficients in each block is computed and summed, as illustrated in FIG. 3. In other words, the difference in the i-th block is computed as follows:

$${d}_{i} = {\sum }_{j ∈ {i}^{th} block}^{} {\{ {c}_{ref , i , j} - {c}_{proc , i , j} \}}^{2} \qquad ( 1 )$$

where c_{ref,i,j} is a wavelet coefficient of the i-th block of the reference video and c_{proc,i,j} is a wavelet coefficient of the corresponding processed video. This will produce 10 values that can be represented as a vector, assuming that a 3-level wavelet transform is applied. Each element of the vector represents the difference of the corresponding subband block. Repeating this procedure over the entire frames produces a sequence of vectors. In other words, the difference vector of the l-th frame is represented as follows:

$${D}_{l} = [ \begin{matrix}{d}_{l , 1} \\ {d}_{l , 2} \\ ⋮ \\ ⋮ \\ {d}_{l , K}\end{matrix} ] \qquad ( 2 )$$

where

$${d}_{l , i} = {\sum }_{j ∈ i - thblock}^{} {( {c}_{ref , l , i , j} - {c}_{proc , l , i , j} )}^{2}$$

is the sum of the squared errors in the i-th block, c_{ref,l,i,j} is a wavelet coefficient of the i-th block of the l-th frame of the reference video, K is the number of blocks in the 2-D wavelet transform, and c_{proc,l,i,j} is a wavelet coefficient of the i-th block of the l-th frame of the processed video. It is noted that there are many other ways to compute the difference such as absolute differences.

Finally, the average of these vectors over the entire frames is computed as follows:

$$D = [ \begin{matrix}{d}_{1} \\ {d}_{2} \\ ⋮ \\ ⋮ \\ {d}_{K}\end{matrix} ] = \frac{1}{L} {\sum }_{l = 1}^{L} {D}_{l} \qquad ( 3 )$$

In the present invention, a number is computed as a weighted sum of the elements of the average vector and the number will be used as an objective measurement of the processed video. In other words, this new number is computed as follows:
y=W^{T}D
where W=[w₁,w₂, . . . , w_{K}]^{T} is a weight vector, D=[d₁,d₂, . . . , d_{K}]^{T} and K is the size of the vector.

### Embodiment 2

The difference in the i-th block of equation (1) is computed by summing the difference of the wavelet coefficients for each pixel. However, the human eye may not notice the difference between pixels whose difference is smaller than a threshold. Thus, the difference in the i-th block may be computed to take into account these characteristics of the human visual system as follows:

$${d}_{i} = {\sum }_{{j ∈ {i}^{th} block}_{\vert {c}_{ref , i , j} - {c}_{proc , i , j} \vert > {t}_{0}}}^{} {\{ {c}_{ref , i , j} - {c}_{proc , i , j} \}}^{2}$$

where t₀ is the threshold.

### Embodiment 3

The difference vector of equation (3) represents only spatial frequency differences. In order to take into account the temporal frequency differences, a 3-D wavelet transform can be applied. However, applying a 3-D wavelet transform to a video is a very expensive operation. It requires a large amount of memory and takes a long processing time. In the present invention, a modified 3-D wavelet transform is provided to take into account the temporal frequency characteristics of videos. However, it is noted that one may use the conventional 3-D wavelet transform and still benefits from the teaching of the present invention.

After computing the difference vector of equation (2) over the entire frames, a sequence of difference vectors is obtained. The sequence of difference vectors can be arranged as a 2-dimensional array with a difference vector as a column of the 2-dimensional array (FIG. 4a). Then, each row of the 2-dimensional array shows how the difference of each subband block varies temporally. In order to compute temporal frequency characteristics, a 1-dimensional wavelet transform is applied to each row of the 2-dimensional array whose columns are the sequence of the difference vectors.

First, a window 140 is applied to each row of the 2-dimensional array producing a segment of the row and the 1-dimensional wavelet transform is applied to the segment in the temporal direction (FIG. 4a). Then, the squared sum of each subband of the 1-dimensional wavelet transform of the j-th row of the l-th widow is computed as follows:

$${e}_{l , j , i} = {\sum }_{k ∈ {i}^{th} subband}^{} {( {c}_{l , j , i , k} )}^{2}$$

where l represents the l-th window, j the j-th row, and i the i-th subband. This procedure is illustrated in FIG. 4b. This operation is repeated for all rows and all the values are represented as a vector as follows:

$${E}_{l} = [ \begin{matrix}⋮ \\ ⋮ \\ ⋮ \\ {e}_{l , j , 1} \\ {e}_{l , j , 2} \\ {e}_{l , j , 3} \\ {e}_{l , j , 4} \\ ⋮ \\ ⋮ \\ ⋮\end{matrix} ]$$

assuming that the level of the 1-dimensional wavelet transform is 3. After the summation, the size of the resulting vector is larger than that of the original vectors. For instance, if the level of the 1-dimensional wavelet transform is 3 and the size of the original vectors is K, the size of the resulting vector will be 4K. Then, the window is moved by a predetermined amount and the procedure is repeated. After finishing the procedure over the entire sequence of vectors, a new sequence of vectors, whose size is larger than that of the original vectors, is obtained. This new sequence of vectors contains information on temporal frequency characteristics as well as spatial frequency characteristics. As previously, the average of these vectors is computed. In other words, an average vector is obtained as follows:

$$E = [ \begin{matrix}{e}_{1} \\ {e}_{2} \\ ⋮ \\ ⋮ \\ {e}_{4 K}\end{matrix} ] = \frac{1}{{L}^{′}} {\sum }_{l = 1}^{{L}^{′}} {E}_{l}$$

where L′ is the number of vectors that contain information on temporal frequency characteristics as well as spatial frequency characteristics. Although the modified 3-dimensional wavelet transform is used to compute the spatio-temporal frequency characteristics in the above procedure, there are many other ways to compute differences in spatial and temporal frequencies. For instance, the conventional 3-dimensional wavelet transform or 3-D Fourier transform can be used to produce a number of parameters that represent spatio-temporal frequency components. These differences in spatial and temporal frequencies are represented as a vector and the optimization technique, which is described in the next embodiment, is applied to find the best linear combination of the differences, producing a number that will be used as an objective score. It is noted that there are many other transforms which can be used for computing spatial and temporal frequencies, including the Haar transform and the discrete cosine transform.

### Embodiment 4

Whether one uses the 2-dimensional wavelet transform or the modified 3-dimensional wavelet transform or the conventional 3-dimensional wavelet transform, a single vector eventually represents the difference between the source and the processed videos. From this vector, a number needs to be computed as a weighted sum of the elements of the vector so that the number will be used as an objective score. In other words, this new number is generated as follows:
Y=W^{T}D (4)
where the superscript T represents transpose, W=[w₁,w₂, . . . ,w_{K}]^{T}, D=[d₁,d₂, . . . ,d_{K}]^{T} and K is the size of the vector.

Let x be the subjective score of the processed video such as DMOS (difference mean opinion score). Then, x and y can be considered as random variables. The goal is to make the correlation coefficient between x and y as high as possible by carefully choosing the weight vector W. It is noted that the absolute value of the correlation coefficient is important. In other words, two objective testing methods, whose correlation coefficients are 0.9 and −0.9, are considered to provide the same performance.

The correlation coefficient between two random variables is defined as follows:

$$ρ = \frac{Cov ( x , y )}{\sqrt{Var ( x ) Var ( y )}} .$$

By substituting y=W^{T} D, ρ becomes

$$ρ = \frac{Cov ( x , {W}^{T} D )}{\sqrt{Var ( x ) Var ( {W}^{T} D )}} = \frac{Cov ( x , {W}^{T} D )}{\sqrt{Var ( x ) {W}^{T} {\sum }_{D} W}} = \frac{E ( x {W}^{T} D ) - {m}_{x} E ( {W}^{T} D )}{\sqrt{Var ( x ) {W}^{T} {Σ}_{D} W}}$$

where Σ_{D} is the covariance matrix of D of equation (4) and E(●) is the expectation operator. For random variable x, the expectation is computed as follows:
E(x)=∫_{-∞}^{∞}xfₓ(x)dx
where fₓ(x) is the probability density function of x.

Without loss of generality, it may be assumed that mₓ=0 and Var(x)=1, which can be done by normalization and translation. Such normalization and translation do not affect the correlation coefficient with other random variables. Then, the correlation coefficient is expressed by

$$ρ = \frac{{W}^{T} E ( x D )}{\sqrt{Var ( x ) {W}^{T} {Σ}_{D} W}} = \frac{{W}^{T} Q}{\sqrt{{W}^{T} {Σ}_{D} W}}$$

where Q=E(xD).

The goal is to find W that maximizes the correlation coefficient ρ. In order to simplify the equation, ρ² may be maximized instead of ρ since the optimal weight vector W will be the same. Then, ρ² is given by

$${ρ}^{2} = \frac{( {W}^{T} Q ) {( {W}^{T} Q )}^{T}}{{W}^{T} {Σ}_{D} W} = \frac{{W}^{T} {QQ}^{T} W}{{W}^{T} {Σ}_{D} W} = \frac{{W}^{T} {Σ}_{Q} W}{{W}^{T} {Σ}_{D} W}$$

where Σ_{Q}=QQ^{T}. Since the goal is to find W that maximizes ρ², the gradient of ρ² should be computed. Now it is straightforward to compute the gradient of ρ² as follows:

$$\frac{\partial {ρ}^{2}}{\partial W} = \frac{\partial }{\partial W} [ {W}^{T} {Σ}_{Q} {W ( {W}^{T} {Σ}_{D} W )}^{- 1} ] \\ = 2 {Σ}_{Q} {W ( {W}^{T} {Σ}_{C} W )}^{- 1} - 2 {Σ}_{D} W ( {W}^{T} {Σ}_{Q} W ) {( {W}^{T} {Σ}_{D} W )}^{- 2} = 0 \\ = > {Σ}_{Q} W - {Σ}_{D} W ( {W}^{T} {Σ}_{Q} W ) {( {W}^{T} {Σ}_{D} W )}^{- 1} = 0 \\ = > {Σ}_{Q} W - {Σ}_{D} W {ρ}^{2} = 0 \\ = > {Σ}_{Q} W = {Σ}_{D} W {ρ}^{2} \\ = > {Σ}_{D}^{- 1} {Σ}_{Q} W = {ρ}^{2} W .$$

As can be seen in the above equations, W is an eigenvector of Σ_{D}⁻¹Σ_{Q} and ρ² is an eigenvalue of Σ_{D}⁻¹Σ_{Q}. Therefore, the eigenvectors of Σ_{D}⁻¹Σ_{Q} are first computed and the eigenvector corresponding to the largest eigenvalue λ is used as the optimal weight vector W. Since λ=ρ², the correlation coefficient will be the largest when the eigenvector corresponding to the largest eigenvalue is used as the optimal weight vector W.

It is noted that vector D in equation (4) can be any vector. For example, each element of vector D may represent any measurements of video quality and the proposed optimization procedure can be used to find the optimal weight vector W, which provides the largest correlation coefficient with the subjective scores. In other words, instead of using the wavelet transform to compute differences in the spatial and temporal frequency components, one can use any other measurements to measure video quality and then utilize the optimization method to find the best linear combination of various measurements. Then, the final objective score will provide the largest correlation coefficient with the subjective scores.

What is claimed is:

1. An optimization method that finds the optimal weight vector which provides the maximum correlation coefficient, comprising the steps of:
(a) computing a vector, Q=E(xD), where E(●) represents an expectation operator, x is a random variable representing a plurality of scalar values and D is a random vector representing a plurality of parameter vectors;
(b) computing Σ_{D}, which is the covariance matrix of said random vector D;
(c) computing Σ_{Q}=QQ^{T};
(d) computing the eigenvectors of Σ_{D}⁻¹Σ_{Q}; and
(e) selecting the eigenvector that corresponds to the largest eigenvalue of Σ_{D}⁻¹Σ_{Q} as an optimal weight vector Wₒₚₜ.

2. An optimization method that finds the best linear combination of various parameters that are obtained for objective measurement of video quality, comprising the steps of:
(a) computing a vector, Q=E(xD), where E(●) represents an expectation operator, x is a random variable representing a plurality of subjective scores and D is a random vector representing a plurality of objective parameter vectors;
(b) computing Σ_{D}, which is the covariance matrix of said random vector D;
(c) computing Σ_{Q}=QQ^{T};
(d) computing the eigenvectors of Σ_{D}⁻¹Σ_{Q};
(e) selecting the eigenvector that corresponds to the largest eigenvalue of Σ_{D}⁻¹Σ_{Q} as an optimal weight vector Wₒₚₜ; and
(f) producing an objective score, which is used as an objective score for objective measurement of video quality, by computing Wₒₚₜ^{T}Vₚ where Vₚ is a parameter vector.
